(19) United States
(12) Patent Application Publication
(10) Pub. No.: US 2012/0085242 A1
(43) Pub. Date: Apr. 12, 2012

(54) HALOGEN POPCORN MAKER WITH STIRRING ARM

(75) Inventor: ENOCH LAM, Hong Kong (HK)

(73) Assignees: UNION INDUSTRIES (HK) LTD, HONG KONG (HK); ENOCH LAM, HONG KONG (HK)

(21) Appl. No.: 12/898,761

(22) Filed: Oct. 6, 2010

(51) Int. Cl. A23L 1/18

(52) U.S. Cl. 99/323.7

(57) ABSTRACT

A halogen popcorn maker with stirring arm includes a base, an aluminium container and a transparent lid. A halogen tube, a thermostat and a synchronised machine are installed in the base. A stirring arm is fixed to the aluminium container by a bolt and a bolt nut where the bolt is connected to the synchronised machine by a connecting shaft. The present invention allows popcorn to be heated and popped evenly without being burnt. In addition, the popcorn maker is easy for dismantlement in the purpose of washing.

### BACKGROUND OF THE INVENTION

1. Technical Field/Field of the Invention

The present invention involves the food processing equipment which is used for popcorn making.

2. Background Art

Ordinary popcorn makers have unsatisfactory results in popping popcorns because the heat generators installed in the popcorn makers cannot transmit the heat efficiently. Consequently, popping popcorn becomes time consuming, unequally and some even incompletely. Additionally, the part that used to hold the kernels for popping cannot be dismantled for cleaning purposes which has caused great inconvenience.

### BRIEF SUMMARY OF THE INVENTION

The present invention ensures an outstanding result in relation to heat generation by using a halogen tube to generate heat, wherein the halogen tube is close to the aluminium container which allows the heat generated to be transmitted by noncontact radiation to the aluminium container efficiently. This can also overcome the problem of traditional heating wire which requires direct contact to the aluminium container. When the power is on, the stirring arm will start to stir the popcorn constantly in the aluminium container. The popcorn will be heated evenly and start popping after three to five minutes. It is assumed that all popcorn has popped if there is no sound of popping popcorn in three seconds. Users should switch off the popcorn maker to prevent the popcorn from being burnt. Also, the thermostat cuts off the power when the halogen tube is overheated to prevent the popcorn from being burnt. The transparent lid can be served as a bowl to hold the popcorn by using the small lid provided to cover the apertures.

Furthermore, the aluminium container and all food contact parts can be dismantled easily for cleaning purposes and they are dishwasher safe.

### BRIEF DESCRIPTION OF THE DRAWINGS

FIG. 1 is a cross-sectional view of the halogen popcorn maker with all its parts and components

### DETAILED DESCRIPTION OF THE INVENTION

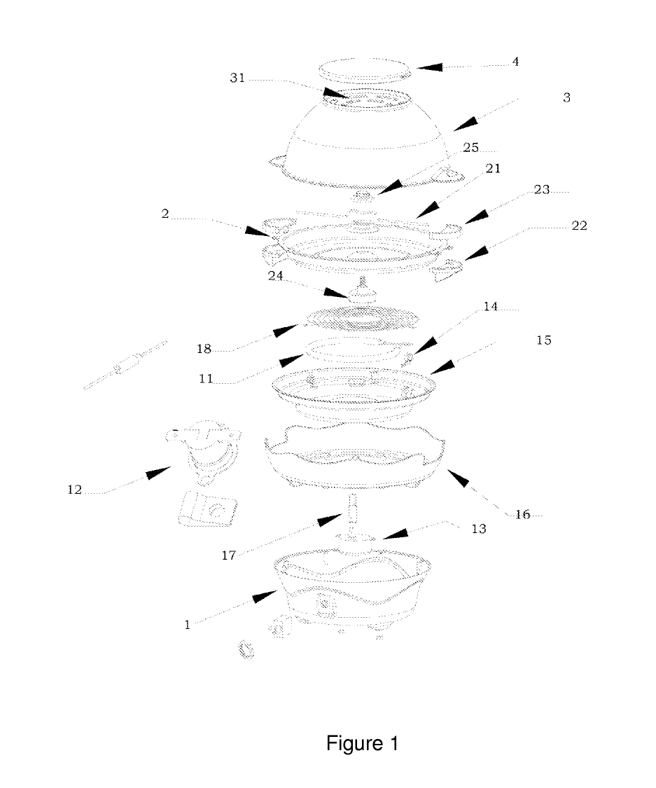

The present invention is a halogen popcorn maker with stirring arm, which can produce popcorn effectively. The popcorn maker includes a base (1), an aluminium container (2) and a transparent lid (3). See FIG. 1. A halogen tube (11), a thermostat (12) and a synchronised machine (13) are installed in the base (1). The halogen tube (11) is fixed on the reflecting plate (15) by a tube fixer (14), of which the reflecting plate (15) is installed inside the base (1). A net for protection purposes (18) is installed between the halogen tube (11) and the aluminium container (2) whereas a heat insulator (16) is installed between the reflecting plate (15) and the base (1). A stirring arm (21) is fixed on the aluminium container (2) by a bolt (24) and a bolt nut (25). The bolt (24) is connected to a synchronised machine (13) by a connecting shaft (17). Two handles (22) are installed on the sides of the aluminium container (2) and the handles (22) are wrapped by a protection cover (23). The handles are used for turning the aluminium container around. The aluminium container (2) is covered by a transparent lid (3) which has apertures (31) on the top. A small lid (4) is included for the purposes of covering the apertures (31) when using the transparent lid as a bowl to hold the popcorn.

The invention claimed is:

1. A halogen popcorn maker with stirring arm, which comprises a base, an aluminium container and a transparent lid, wherein
A halogen tube, a thermostat and a synchronised machine are installed in the base; a stirring arm is fixed on the aluminium container by a bolt and bolt nut; and the bolt is connected to the synchronised machine by a connecting shaft.

2. A halogen popcorn maker with stirring arm as in claim 1, further comprising a reflecting plate which is installed inside the base, wherein the halogen tube is fixed on the reflecting plate by a tube fixer; and a heat insulator is installed between the reflecting plate and the base.

3. A halogen popcorn maker with stirring arm as in claim 1, further comprising a halogen tube to generate heat and the heat is transmitted to the aluminium container by noncontact radiation.

4. A halogen popcorn maker with stirring arm as in claim 1, further comprising a thermostat which will cut off the power temporarily when the halogen tube is overheated.

5. A halogen popcorn maker with stirring arm as in claim 1, further comprising a handle which is installed on both sides of the aluminium container.

6. A halogen popcorn maker with stirring arm as in claim 1, in which the handle is wrapped with a protection cover.

7. A halogen popcorn maker with stirring arm as in claim 1, further comprising a transparent lid which has apertures on the top, where a small lid is used to cover the apertures when necessary.
